(19) United States
(12) Patent Application Publication
(10) Pub. No.: US 2007/0222875 A1
(43) Pub. Date: Sep. 27, 2007

(54) Semiconductor device

(75) Inventor: Susumu Moriya, Kawasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki (JP)

(21) Appl. No.: 11/500,439

(22) Filed: Aug. 8, 2006

(30) Foreign Application Priority Data
Mar. 22, 2006 (JP) 2006-079062

(51) Int. Cl. H04N 5/335; H04N 3/14

(52) U.S. Cl. 348/294

(57) ABSTRACT

A semiconductor device includes a semiconductor element having an upper surface where an imaging area is formed; a transparent member separated from the semiconductor element by a designated distance and facing the semiconductor element; and a sealing member configured to seal an edge part of the semiconductor element and an edge surface of the transparent member; wherein a groove forming part is formed in the transparent member, the groove forming part being situated at an edge surface side of the transparent member outside of an external edge of the imaging area of the semiconductor element.

### BACKGROUND OF THE INVENTION

1. Field of the Invention

The present invention generally relates to semiconductor devices, and more specifically, to a semiconductor device having a transparent member.

2. Description of the Related Art

A solid-state image sensing device formed by packaging and modularizing a solid-state image sensor with a transparent member such as glass, a wiring board, wiring connecting the solid-state image sensor and the wiring board, sealing resin, and others, is well-known. Here, the solid-state image sensing device is, for example, an image sensor such as a Charge Coupled Device (CCD) or a Complementary Metal Oxide Semiconductor (CMOS).

FIG. 1 is a cross-sectional view of a related art solid-state image sensing device. FIG. 2 is a plan view of the related art solid-state image sensing device. FIG. 1 is a cross-sectional view taken along a line X-X of FIG. 2.

Referring to FIG. 1 and FIG. 2, a solid-state image sensing device 10 has a structure where a solid-state image sensor 8 is mounted on a wiring board 4 having a lower surface where plural outside connection terminals 2 are formed, via a die bonding member 6. An imaging area 9 where a large number of micro lenses 9 are provided is formed on an upper surface of the solid-state image sensor 8. The solid-state image sensor 8 is electrically connected to the wiring board 4 by a bonding wire 7.

In addition, a transparent member 1 such as glass is mounted above the solid-state image sensor 8 via an adhesive agent layer 3. Parts of the solid-state image sensor 8 and the wiring board 4 where the bonding wires 7 are provided, external circumferential parts of the transparent member 1, and side parts of the adhesive agent layer 3 are sealed by sealing resin 5.

Thus, the solid-state image sensor 8 is sealed by the transparent member 1 and the sealing resin 5. See Japan Laid-Open Patent Application Publications No. 62-67863, No 2000-323692, and No. 2002-16194.

However, coefficients of thermal expansion of members forming the solid-state image sensing device 10 shown in FIG. 1 are different from each other. For example, the coefficient of thermal expansion of silicon (Si) used as the solid-state image sensor 8 is 3×10⁻⁶/° C., the coefficient of thermal expansion of glass used as the transparent member 1 is 7×10⁻⁶/° C., the coefficient of thermal expansion of the sealing resin 5 is 8×10⁻⁶/° C., and the coefficient of thermal expansion of the wiring board 4 is 16×10⁻⁶/° C.

In addition, for example, the temperature inside of a reflow hearth in a reflow process for mounting a package such as a camera module on the wiring board 4 reaches around 260° C. Heat is applied as a reliability test of the solid-state image sensing device 10. Furthermore, in normal use of the solid-state image sensing device 10, the solid-state image sensing device 10 may be put under atmospheric conditions wherein the temperature in summer may be higher than 80° C.

Accordingly, under the atmospheric conditions wherein such a temperature change is made, the members may expand or contract by heat due to the difference of the coefficients of thermal expansion of the members, so that the transparent member 1 may receive stress from the sealing resin 5 and/or the wiring board 4.

Furthermore, the sealing resin may absorb moisture from outside the semiconductor device 10 and expand so that the transparent member 1 may receive the stress from the sealing resin 5.

As a result of this, as shown in FIG. 3, a crack may be generated from an external peripheral part of the transparent member 1 by the stress generated due to the difference of the coefficients of thermal expansion of the members forming the solid-state image sensing device 10 or expansion based on moisture absorption of the sealing resin 5. Here, FIG. 3 is a cross-sectional view for explaining problems of the solid-state image sensing device 10 shown in FIG. 1.

If such a crack 6 in the transparent member 1 progresses as shown in FIG. 3 so as to reach the vicinity of the imaging area 9, the refraction of light transmitting through the transparent member 1 is no longer uniform. As a result of this, diffuse reflection of the light may occur so that an abnormality such as flare may be generated in an image formed on the imaging area. In addition, due to the progressing of the crack, the transparent member 1 such as glass may be destroyed.

### SUMMARY OF THE INVENTION

Accordingly, the present invention may provide a novel and useful semiconductor device solving one or more of the problems discussed above.

Another and more specific object of the present invention may be to provide a semiconductor device having high reliability, wherein the crack in the transparent member, caused by the stress generated due to the difference of the coefficients of thermal expansion of the member forming the solid-state image sensing device or expansion based on moisture absorption by the sealing resin, is prevented from progressing to the vicinity of the imaging area of the semiconductor device.

The above object of the present invention is achieved by a semiconductor device, including: a semiconductor element having an upper surface where an imaging area is formed; a transparent member separated from the semiconductor element by a designated distance and facing the semiconductor element; and a sealing member configured to seal an edge part of the semiconductor element and an edge surface of the transparent member; wherein a groove forming part is formed in the transparent member, the groove forming part being situated at an edge surface side of the transparent member outside of an external edge of the imaging area of the semiconductor element.

A cross section of the groove forming part may have a configuration wherein a bottom surface is a plane surface and side surfaces are formed from the bottom surface in a direction substantially perpendicular to the bottom surface. A cross section of the groove forming part may have a substantially V-shaped configuration. A U-shaped cross section of the groove forming part may have a configuration wherein a bottom surface is a curved surface and side surfaces are formed from the bottom surface in a direction substantially perpendicular to the bottom surface.

A single one of the groove forming part may be formed in the vicinity of each of the four sides of a main surface of the transparent member and along the corresponding side. A plurality of the groove forming parts may be formed in the vicinity of each of the four sides of a main surface of the transparent member and along the corresponding side.

According to an embodiment of the present invention, it is possible to provide the semiconductor device having high reliability, wherein the crack in the transparent member, caused by the stress generated due to the difference of the coefficients of thermal expansion of the member forming the solid-state image sensing device or expansion based on moisture absorption by the sealing resin, is prevented from progressing to the vicinity of the imaging area of the semiconductor device.

Other objects, features, and advantages of the present invention will be come more apparent from the following detailed description when read in conjunction with the accompanying drawings.

### BRIEF DESCRIPTION OF THE DRAWINGS

FIG. 1 is a cross-sectional view of a related art solid-state image sensing device;

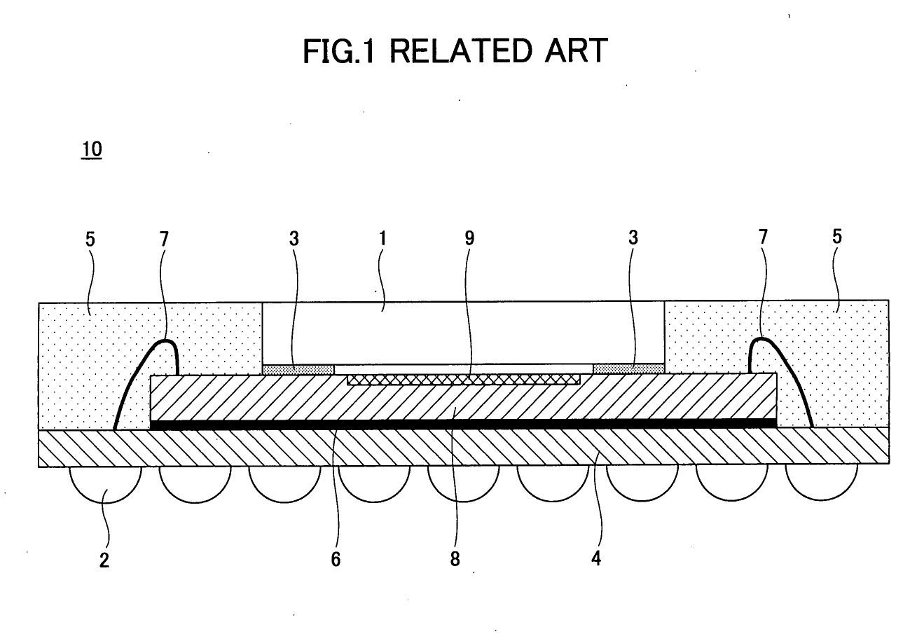

FIG. 2 is a plan view of the related art solid-state image sensing device;

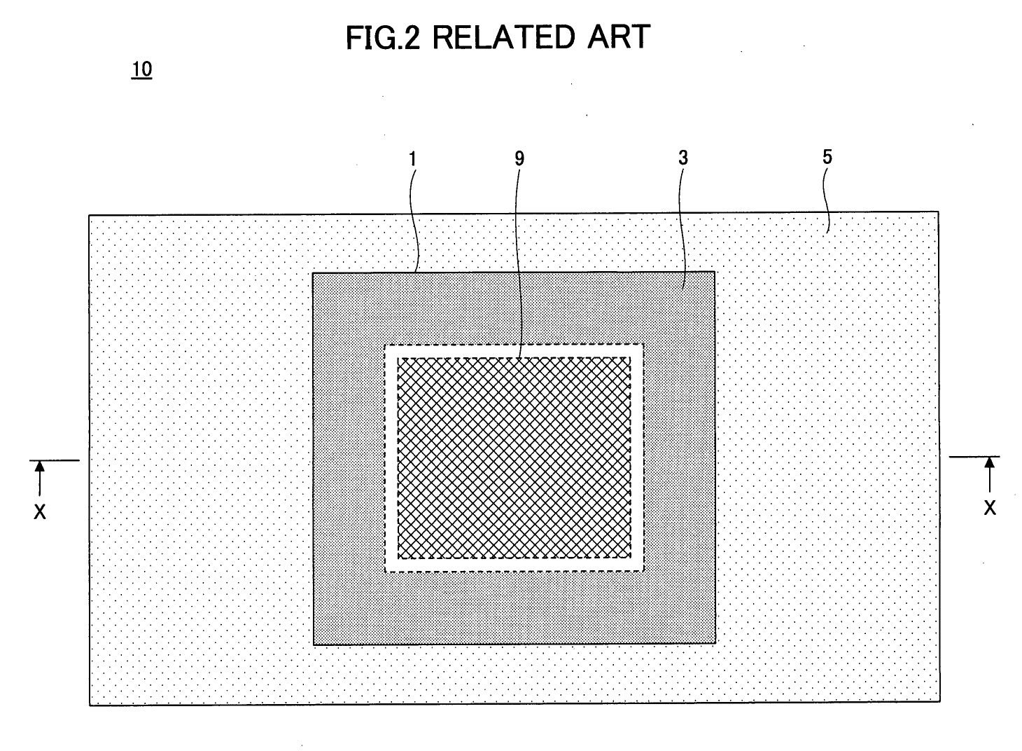

FIG. 3 is a cross-sectional view for explaining problems of the solid-state image sensing device 10 shown in FIG. 1;

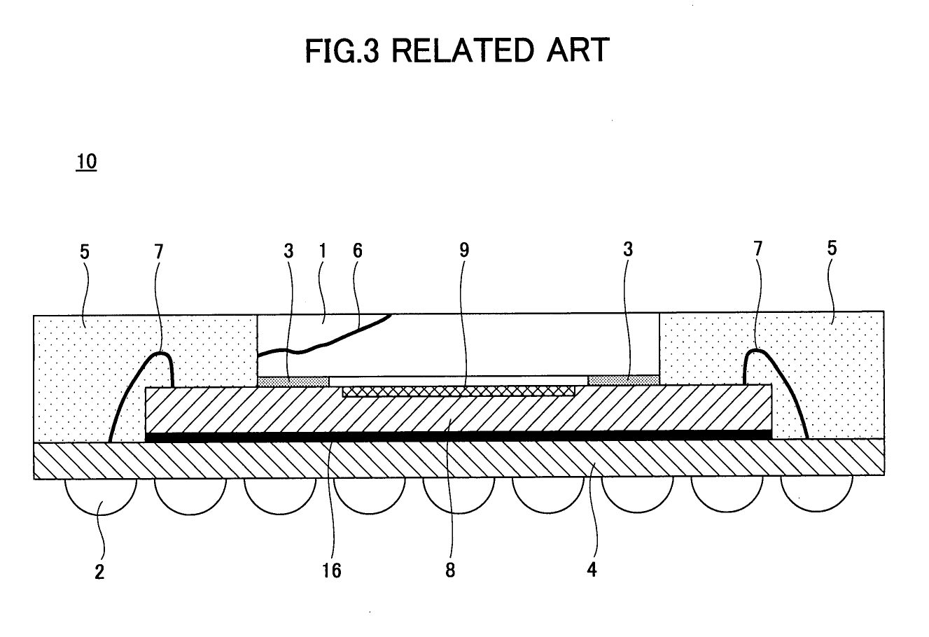

FIG. 4 is a cross-sectional view of a solid-state image sensing device of a first embodiment of the present invention;

FIG. 5 is a plan view of the solid-state image sensing device shown in FIG. 4;

FIG. 6 is a cross-sectional view showing a state where progress of a crack of a transparent member is prevented by a groove forming part in the solid-state image sensing device shown in FIG. 4;

FIG. 7 is a cross-sectional view of a solid-state image sensing device of a second embodiment of the present invention;

FIG. 8 is a cross-sectional view showing a state where progress of a crack of a transparent member is prevented by a groove forming part in the solid-state image sensing device shown in FIG. 7;

FIG. 9 is a cross-sectional view of a solid-state image sensing device of a third embodiment of the present invention;

FIG. 10 is a cross-sectional view showing a state where progress of a crack of a transparent member is prevented by a groove forming part in the solid-state image sensing device shown in FIG. 9;

FIG. 11 is a first view for explaining a first example of a manufacturing method of the solid-state image sensing device of the embodiment of the present invention;

FIG. 12 is a second view for explaining the first example of the manufacturing method of the solid-state image sensing device of the embodiment of the present invention;

FIG. 13 is a third view for explaining the first example of the manufacturing method of the solid-state image sensing device of the embodiment of the present invention;

FIG. 14 is a fourth view for explaining the first example of the manufacturing method of the solid-state image sensing device of the embodiment of the present invention;

FIG. 15 is a view for explaining a second example of the manufacturing method of the solid-state image sensing device of the embodiment of the present invention; and

FIG. 16 is a plan view of a solid-state image sensing device manufactured by the second example of the manufacturing method of the solid-state image sensing device of the embodiment of the present invention.

### DETAILED DESCRIPTION OF THE PREFERED EMBODIMENTS

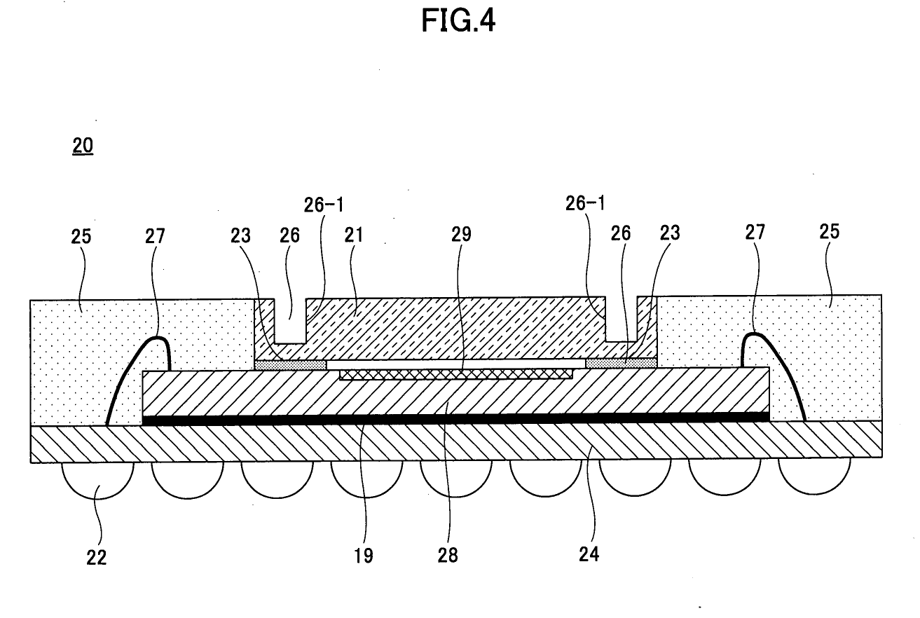

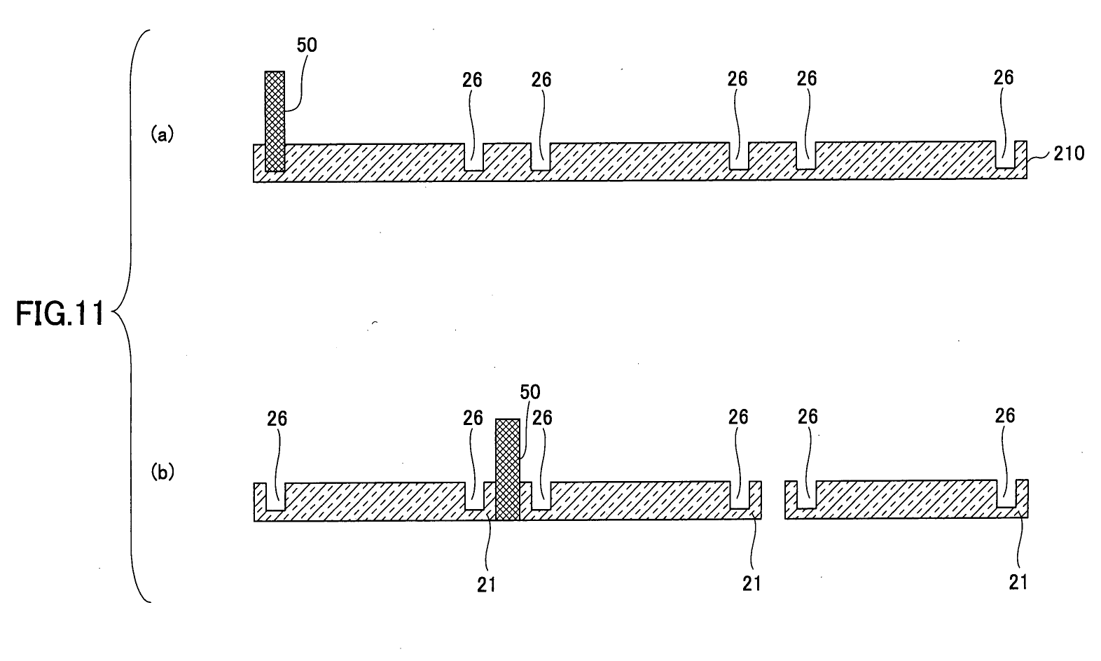

A description is given below, with reference to the FIG. 4 through FIG. 16 of embodiments of the present invention. More specifically, a semiconductor device of an embodiment of the present invention is discussed with reference to FIG. 4 through FIG. 10 and a manufacturing method of the semiconductor device is discussed with reference to FIG. 11 through FIG. 16.

### [Semiconductor Device]

In the following explanation, a manufacturing method of a solid-state image sensing device is discussed as an example of the present invention.

### 1. Solid-State Image Sensing Device of First Embodiment of the Present Invention

A solid-state image sensing device of a first embodiment of the present invention is discussed with reference to FIG. 4 through FIG. 6.

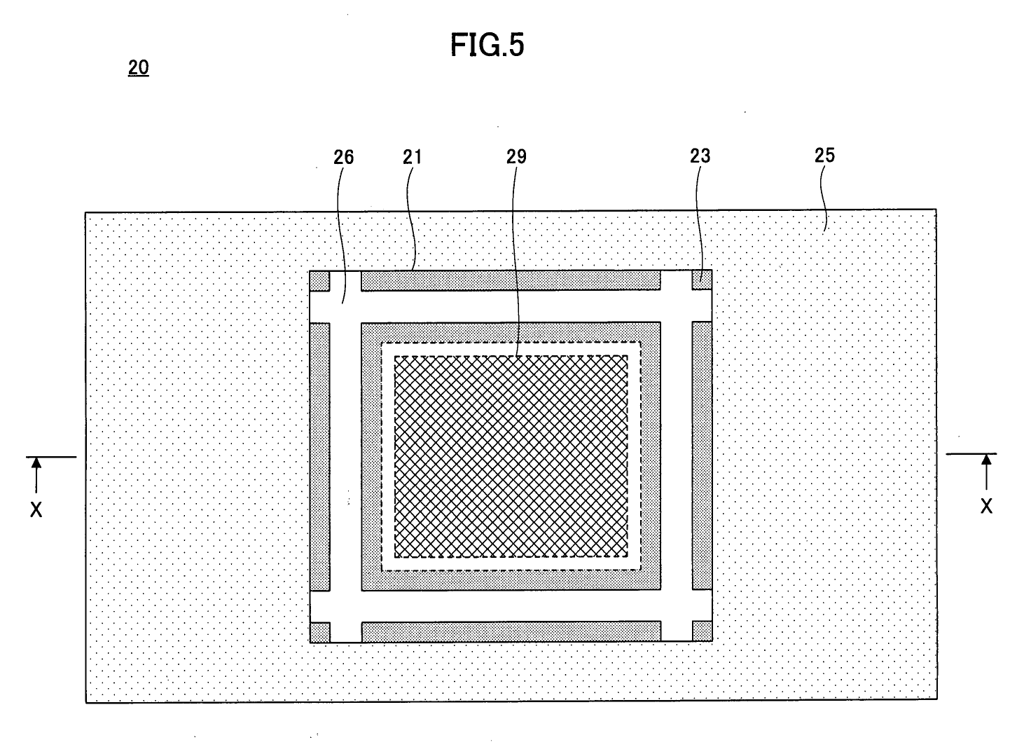

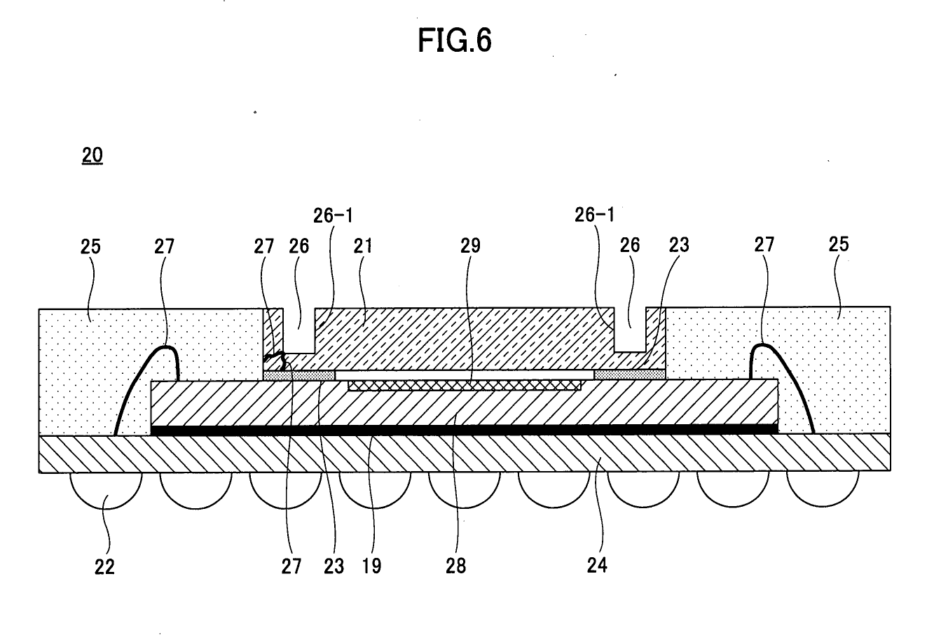

Here, FIG. 4 is a cross-sectional view of the solid-state image sensing device of the first embodiment of the present invention. FIG. 5 is a plan view of the solid-state image sensing device shown in FIG. 4. FIG. 4 is a cross-sectional view taken along a line X-X of FIG. 5. FIG. 6 is a cross-sectional view showing a state where progress of a crack of a transparent member is prevented by a groove forming part in the solid-state image sensing device shown in FIG. 4.

Referring to FIG. 4 and FIG. 5, a solid-state image sensing device 20 of the first embodiment of the present invention has a structure where a solid-state image sensor 28 as a semiconductor element is packaged together with a transparent member 21, bonding wires 27, a wiring board 24, sealing resin 25, and others. The solid-state image sensor 28 is sealed by the transparent member 21 and the sealing resin 25. In other words, the solid-state image sensor 28 is mounted on the wiring board 24 having a lower surface where plural outside connection terminals 22 are formed, via a die bonding member 19.

An imaging area 29 where a large number of micro lenses are provided is formed on a light receiving area of an upper surface of the solid-state image sensor 28. An electrode (not shown) of the solid-state image sensor 28 is connected to an electrode (not shown) of the wiring board 24 by bonding wires 27.

The transparent member 21 is provided above the solid-state image sensor 28 at a designated distance via an adhesive agent layer 23 made of epoxy group resin. A material of the adhesive agent layer 23 is not limited to the epoxy group resin. For example, liquid resin such as ultraviolet curing adhesive agent may be used for the adhesive agent layer 23.

Since the transparent member 21 is provided with the distance from the solid-state image sensor 28, air exists in a space formed by the transparent member 21 and the solid-state image sensor 28.

Due to the difference of the indexes of the refraction between air and the micro lens 29, light incident through the transparent member 21 is effectively incident on a light receiving element, namely a photo diode, formed on a main surface of the solid-state image sensor 28.

Silicon (Si) or the like can be used as a semiconductor substrate forming the solid-state image sensor 28. Furthermore, glass, transparent plastic, crystal, quartz, sapphire, or the like can be used as the transparent member 21. However, the present invention is not limited to these examples.

The solid-state image sensor 28 and parts where the boding wires 27 are provided are covered with the sealing resin 25 so that the upper-most part of the sealing resin 25 is the same height as an upper surface of the transparent member 21, namely a surface opposite to the surface facing the solid-state image sensor 28.

Silicon group resin, acrylic group resin, epoxy resin, or the like, for example, can be used as the sealing resin 25. However, the present invention is not limited to this.

In this embodiment, under this structure, groove forming parts 26 are formed in the vicinities of four sides of the main surface of the plate-shaped transparent member 21 along and parallel to the corresponding sides. See FIG. 5.

In this embodiment, as shown in FIG. 4, a cross section of the groove forming part 26 has a configuration wherein a bottom surface is a plane surface and side surfaces are formed from the bottom surface in a direction substantially perpendicular to the bottom surface. A side surface 26-1 positioned toward the center (inboard) of the transparent member 21 is at the same position as or outside (outboard) of the external edge of the imaging area 29.

Width of the groove forming part 26 in left and right directions may be, for example, equal to or greater than approximately 0.05 mm and equal to or smaller than approximately 0.2 mm. However, as the groove forming part 26 is situated closer to where the imaging area 29 is formed, an oblique light passing through the transparent member 21 may sometimes not be incident on the imaging area 29 depending on forming of the groove forming part 25. Hence, it is preferable to define the position where the groove forming part 26 is to be formed by taking this into consideration.

In addition, incident light in a center direction is reflected on the side surface 26-1 so as to become scattered light. If the scattered light is incident on the imaging area, a fault such as flare may appear in the image. Because of this, an anti-reflection process such as a process for making a surface rough, a reflection prevention film process, a black color process, or the like, may be applied to the side surface 26-1 of the groove forming part 26.

While it depend on properties of the solid-state image sensor 28 and the transparent member 21, the thickness of the transparent member 21 in up and down directions of FIG. 4 is normally equal to or greater than approximately 0.3 mm and equal to or smaller than approximately 1.5 mm in a case of a mega-pixel type sensor. Depth of the groove forming part 26 in up and down directions may be approximately 50 through 90% of the thickness of the transparent member 21.

In the meantime, the coefficient of thermal expansion of silicon (Si) used as the solid-state image sensor 28 is 3×10⁻⁶/° C., the coefficient of thermal expansion of glass used as the transparent member 21 is 7×10⁻⁶/° C., the coefficient of thermal expansion of the sealing resin 25 is 8×10⁻⁶/° C., and the coefficient of thermal expansion of the wiring board 24 is 16×10⁻⁶/° C.

The transparent member 21, the sealing resin 25, and the solid-state image sensor 28 may expand or contract by heat due to the difference of the coefficients of thermal expansion of the members, so that the transparent member 21 may receive stress from the sealing resin 25 and/or the wiring board 24.

Furthermore, the sealing resin 25 may absorb moisture from outside of the solid-state image sensing device 20 and expand so that the transparent member 21 may receive the stress from the sealing resin 25.

As a result of this, a crack 27 may be generated, as shown in FIG. 6, from an external peripheral part of the transparent member 21 by the stress generated due to the difference of the coefficients of thermal expansion of the member forming the solid-state image sensing device 20 or expansion based on moisture absorption of the sealing resin 25.

However, in this embodiment, the groove forming parts 26 are formed in the vicinities of the four sides of the main surface of the plate-shaped transparent member 21 along the four sides. Accordingly, even if the crack 27 is generated, as shown in FIG. 6, the progress of the crack 27 can be stopped by the groove forming part 26, more specifically a corner part of the bottom part of the groove forming part 26 in the example shown in FIG. 6.

Especially, in this embodiment as discussed above, the side surface 26-1 positioned toward the center of the transparent member 21 is at the same position as or outside of the external edge of the imaging area 29. Therefore, it is possible to prevent the crack 27 from progressing inboard to the part of the transparent member 21, the part corresponding to where the imaging area 29 is formed. Accordingly, there is no adverse effect on the refraction of the light transmitting through the transparent member 21. Therefore, a situation where lens performance is drastically decreased so that quality of the image is degraded can be prevented. In addition, it is possible to prevent the transparent member 21 such as glass from being destroyed. Therefore, reliability of the solid-state image sensing device 20 can be improved.

In this embodiment, a single groove forming part 26 is formed in the vicinity of each of the four sides of the main surface of the plate-shaped transparent member 21 and along the corresponding side. However, the present invention is not limited to this. Plural groove forming parts 26 may be formed in the vicinity of each of the four sides of the main surface of the transparent member 21 and along the corresponding side.

### 2. Solid-State Image Sensing Device of Second Embodiment of the Present Invention

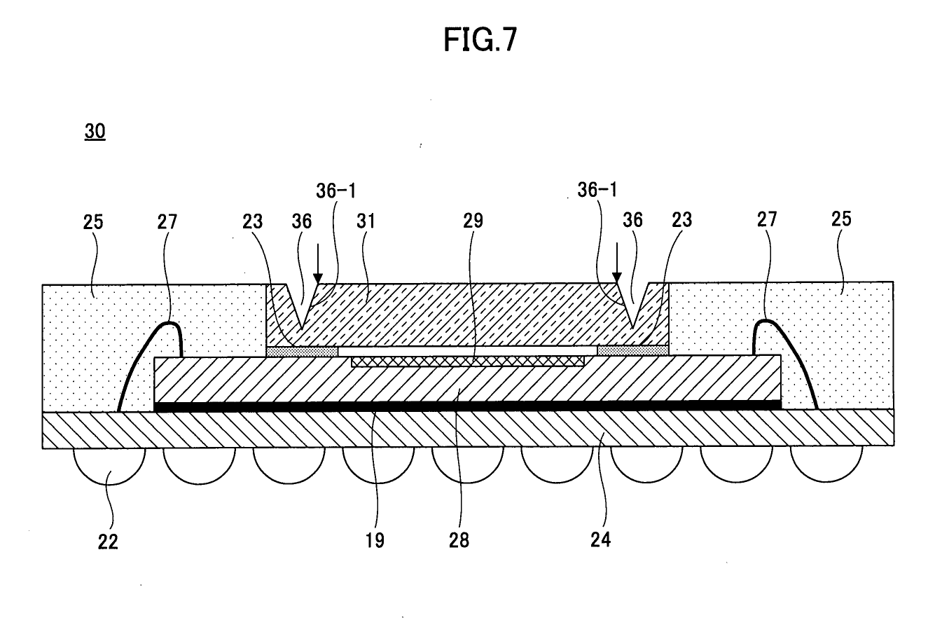

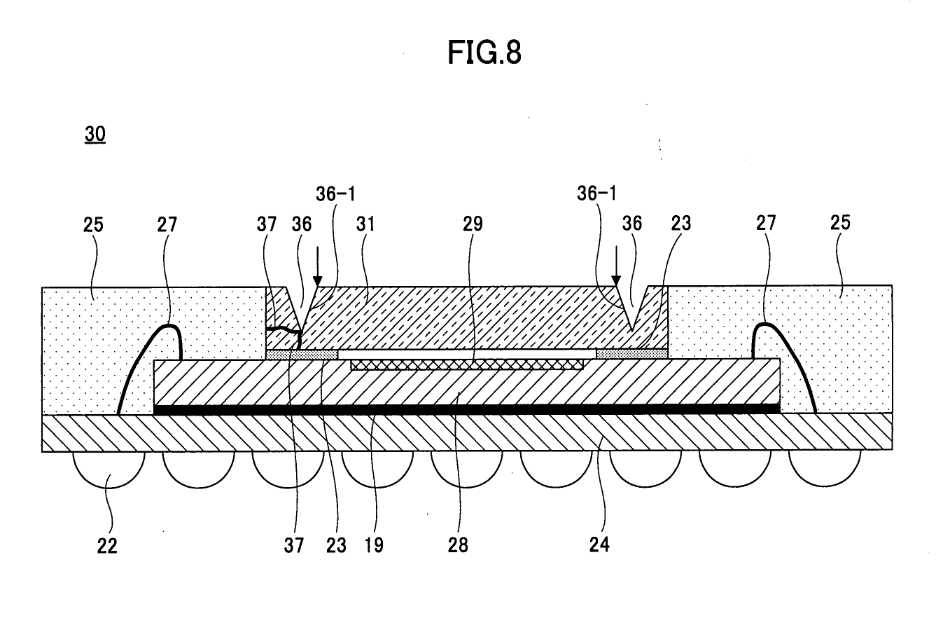

A solid-state image sensing device of a second embodiment of the present invention is discussed with reference to FIG. 7 and FIG. 8.

Here, FIG. 7 is a cross-sectional view of the solid-state image sensing device of the second embodiment of the present invention. FIG. 8 is a cross-sectional view showing a state where progress of a crack of a transparent member is prevented by a groove forming part in the solid-state image sensing device shown in FIG. 7. In the following explanations, parts that are the same as the parts shown in FIG. 4 through FIG. 6 are given the same reference numerals, and explanation thereof is omitted.

In the above-discussed first embodiment of the present invention, the cross section of the groove forming part 26 has a configuration wherein the bottom surface is a plane surface and side surfaces are formed from the bottom surface in the direction substantially perpendicular to the bottom surface. In addition, the side surface 26-1 positioned at the center side of the transparent member 21 is at the same position as or outside of the external edge of the imaging area 29. However, the present invention is not limited to this example. A structure shown in FIG. 7 may be used.

Referring to FIG. 7, in the solid-state image sensing device 30 of the second embodiment of the present invention, groove forming parts 36 are formed in the vicinities of four sides of the main surface of the plate-shaped transparent member 31 along the four sides. The groove forming part 36 has a V-shaped cross section. A part shown by an arrow in FIG. 7, where a side surface forming the V-shaped configuration and a main surface of the transparent member 31 come in contact with each other, is positioned at the same position as or outside of the external edge of the imaging area 29 of the semiconductor element.

Therefore, in this embodiment, as shown in FIG. 8, even if crack 37 is generated, the progress of the crack 37 can be stopped by the groove forming part 36, more specifically a part where the side surfaces forming the V-shaped cross section of the groove forming part 36 come in contact with each other.

In this embodiment, as discussed above, the part where the side surface 36-1 forming the V-shaped cross section and positioned toward the center of the transparent member 31 and the main surface of the transparent member 31 come in contact with each other, is at the same position as or outside of the external edge of the imaging area 39.

Therefore, it is possible to prevent the crack 37 from progressing to the part of the transparent member 31 corresponding to where the imaging area 29 is formed. Accordingly, there is no adverse effect on the refraction of the light transmitting through the transparent member 31. Therefore, a situation where lens performance is drastically decreased so that quality of the image is degraded can be prevented. In addition, it is possible to prevent the transparent member 31 such as glass from being destroyed. Therefore, reliability of the solid-state image sensing device 30 can be improved.

In this embodiment, a single groove forming part 36 is formed in the vicinity of each of the four sides of the main surface of the plate-shaped transparent member 31 and along the corresponding side. However, the present invention is not limited to this. Plural groove forming parts 36 may be formed in the vicinity of each of the four sides of the main surface of the transparent member 31 and along the corresponding side.

### 3. Solid-State Image Sensing Device of Third Embodiment of the Present Invention

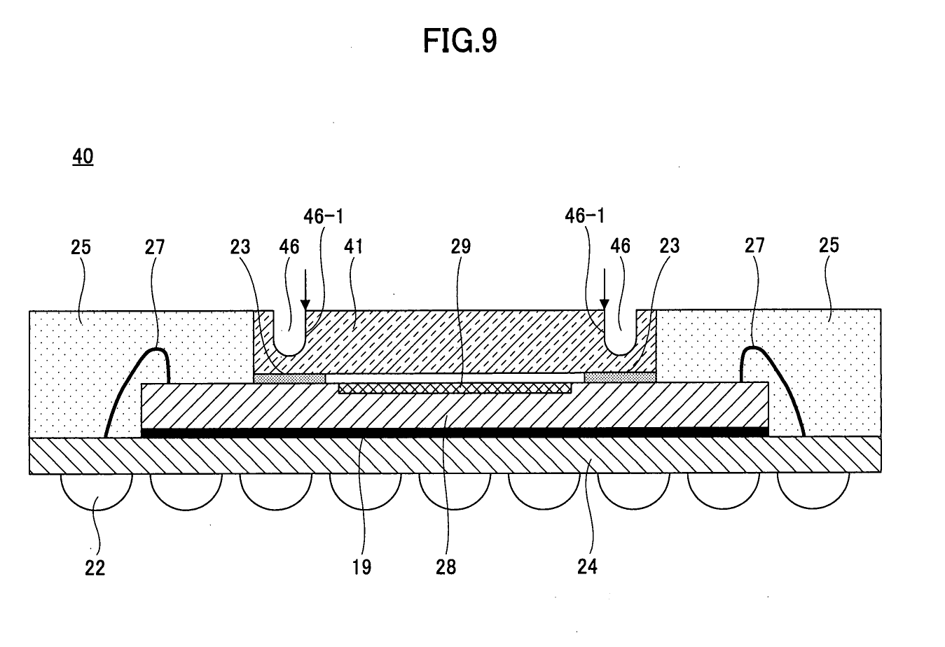

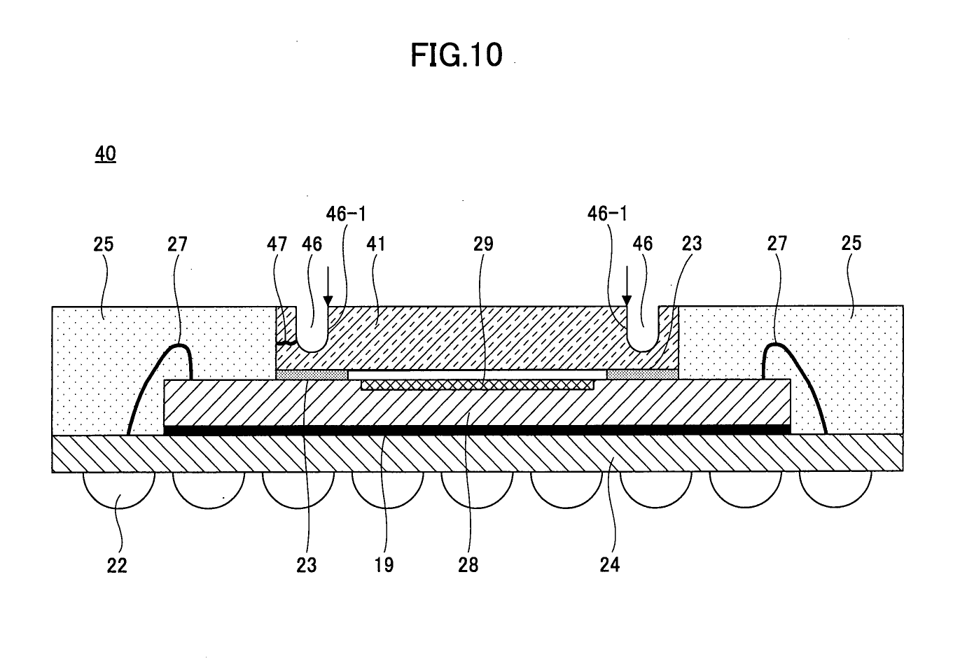

A solid-state image sensing device of a third embodiment of the present invention is discussed with reference to FIG. 9 and FIG. 10.

Here, FIG. 9 is a cross-sectional view of the solid-state image sensing device of the third embodiment of the present invention. FIG. 10 is a cross-sectional view showing a state where progress of a crack of a transparent member is prevented by a groove forming part in the solid-state image sensing device shown in FIG. 9. In the following explanations, parts that are the same as the parts shown in FIG. 4 through FIG. 6 are given the same reference numerals, and explanation thereof is omitted.

In the above-discussed first embodiment of the present invention, the cross section of the groove forming part 26 has a configuration wherein the bottom surface is a plane surface and side surfaces are formed from the bottom surface in the direction substantially perpendicular to the bottom surface. In addition, the side surface 26-1 positioned toward the center of the transparent member 21 is at the same position as or outside of the external edge of the imaging area 29.

In the above-discussed first embodiment of the present invention, the cross section of the groove forming part 36 has a substantially V-shaped configuration. The part where the side surface 36-1 forming the V-shaped cross section of the groove forming part 36 and the main surface of the transparent member 31 come in contact with each other, is at the same position as or outside of the external edge of the imaging area 29.

However, the present invention is not limited to this example. A structure shown in FIG. 9 may be used.

Referring to FIG. 9, in the solid-state image sensing device 40 of the second embodiment of the present invention, groove forming parts 46 are formed in the vicinities of four sides of the main surface of the plate-shaped transparent member 31 along the four sides. The groove forming part 46 has a U-shaped cross section wherein the bottom surface is a curved surface and side surfaces are formed from the bottom surface in a direction substantially perpendicular to the bottom surface.

A part shown by an arrow in FIG. 9 where a side surface 46-1 situated toward the center of the transparent member 41 and a main surface of the transparent member 41 come in contact with each other, is at the same position as or outside of the external edge of the imaging area 29 of the semiconductor element.

Therefore, in this embodiment, as shown in FIG. 10, even if crack 47 is generated, the progress of the crack 47 can be stopped by the groove forming part 46, more specifically a part where the side surfaces forming the U-shaped cross section of the groove forming part 46 and the bottom surface come in contact with each other.

In this embodiment, as discussed above, the part where the side surface 46-1 forming the U-shaped cross section and the main surface of the transparent member 41 come in contact with each other, is at the same position as or outside of the external edge of the imaging area 39.

Therefore, it is possible to prevent the crack 47 from progressing to the part of the transparent member 41 corresponding to where the imaging area 29 is formed. Accordingly, there is no adverse effect on the refraction of the light transmitting through the transparent member 41. Therefore, a situation where lens performance is drastically decreased so that quality of the image is degraded can be prevented. In addition, it is possible to prevent the transparent member 41 such as glass from being destroyed. Therefore, reliability of the solid-state image sensing device 40 can be improved.

In this embodiment, a single groove forming part 46 is formed in the vicinity of each of the four sides of the main surface of the plate-shaped transparent member 41 and along the corresponding side. However, the present invention is not limited to this. Plural groove forming parts 46 may be formed in the vicinity of each of the four sides of the main surface of the transparent member 41 and along the corresponding side.

### [Manufacturing Method of Semiconductor Device]

Next, a manufacturing method of the solid-state image sensing device as discussed above is discussed.

### 1. First Example of a Manufacturing Method of the Solid-State Image Sensing Device

A first example of a manufacturing method of the solid-state image sensing devices 20, 30 and 40 is discussed with reference to FIG. 11 through FIG. 14.

Here, FIG. 11 through FIG. 14 provide first through fourth view for explaining the first example of the manufacturing method of the solid-state image sensing device of the embodiment of the present invention. In the following explanation, an example of the manufacturing method of the solid-state image sensing device 20 is discussed.

Referring to FIG. 11-(a), the transparent board 210 formed by a rectangular shaped glass plate is cut by a cutting blade 50 having a width (edge thickness) of approximately 0.05 through 0.2 mm so that the groove forming parts 26 are formed. The cutting blade 50 used in this process is the same as the cutting blade used for the cutting process of the transparent board 210 shown in FIG. 11-(b).

The groove forming parts 26 are formed in the vicinities of four side of the main surface of the plate-shaped transparent member 21 (being cut pieces of the transparent board 210) along the four sides. See FIG. 5.

While it depend on properties of the solid-state image sensor 28 shown in FIG. 4 and the transparent member 21 shown in FIG. 4, the thickness of the transparent member 21 in up and down directions of FIG. 4 is normally equal to or greater than approximately 0.3 mm and equal to or smaller than approximately 1.5 mm in a case of a mega-pixel type sensor. Depth of the groove forming part 26 in up and down directions cut by the cutting blade 50 may be approximately 50 through 90% of thickness of the transparent board 210.

The cross section of the cutting blade 50 has a configuration wherein a bottom surface is a plane surface and side surfaces are formed from the bottom surface in a direction substantially perpendicular to the bottom surface. The groove forming part having the cross section corresponding to this is formed by the cutting blade 50.

In addition, as discussed with reference to FIG. 4, the side surface 26-1 positioned at the center side of the transparent member is selected so as to at the same position as or outside of the external edge of the imaging area 29.

As discussed above, in the case of the solid-state image sensing device 30, the groove forming part 36 has the cross section having the V shaped configuration. In this case, a cutting blade having a V-shaped cross section is used for forming the groove forming part. In the case of the solid-state image sensing device 40, the groove forming part 46 has the cross section having the U shaped configuration. In this case, a cutting blade having a U-shaped cross section is used for forming the groove forming part.

Next, as shown in FIG. 11-(b), by using the cutting blade 50 used in the process shown in FIG. 11-(a), the transparent board 210 is cut so that an interval between the neighboring groove forming parts 26 is pierced and plural transparent members 21 are formed, which members can be fixed above the solid-state image sensing device 28 in the following process and have both side parts where the groove forming parts 26 are formed.

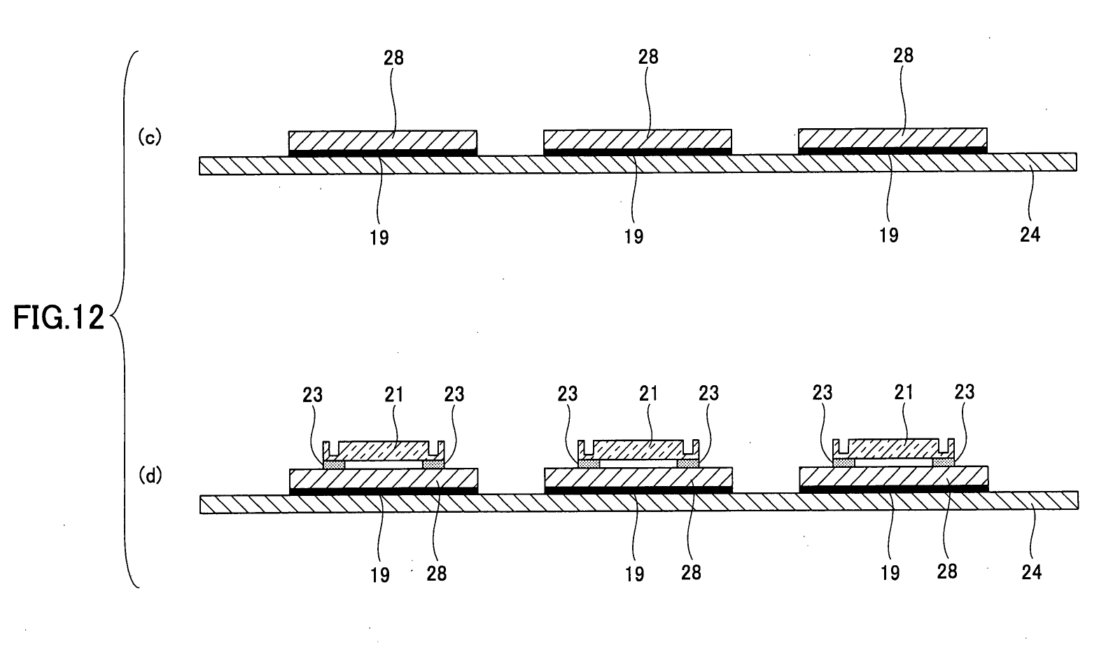

Next, as shown in FIG. 12-(c), the solid-state image sensor 28 is mounted on and fixed to the wiring board 24 via a die bonding member 19.

After that, as shown in FIG. 12-(d), the transparent member 21 formed in the process shown in FIG. 11-(b) is provided above the light receiving surface of the solid-state image sensor 28 mounted on the wiring board 24 with a designated separation distance from the solid-state image sensor 28 via the adhesive layer 23 made of epoxy group resin. The material of the adhesive layer 23 is not limited to the epoxy group resin. For example, an ultraviolet cutting adhesive agent can be used as the material of the adhesive layer 23. The adhesive layer 23 may be formed at the glass side in advance.

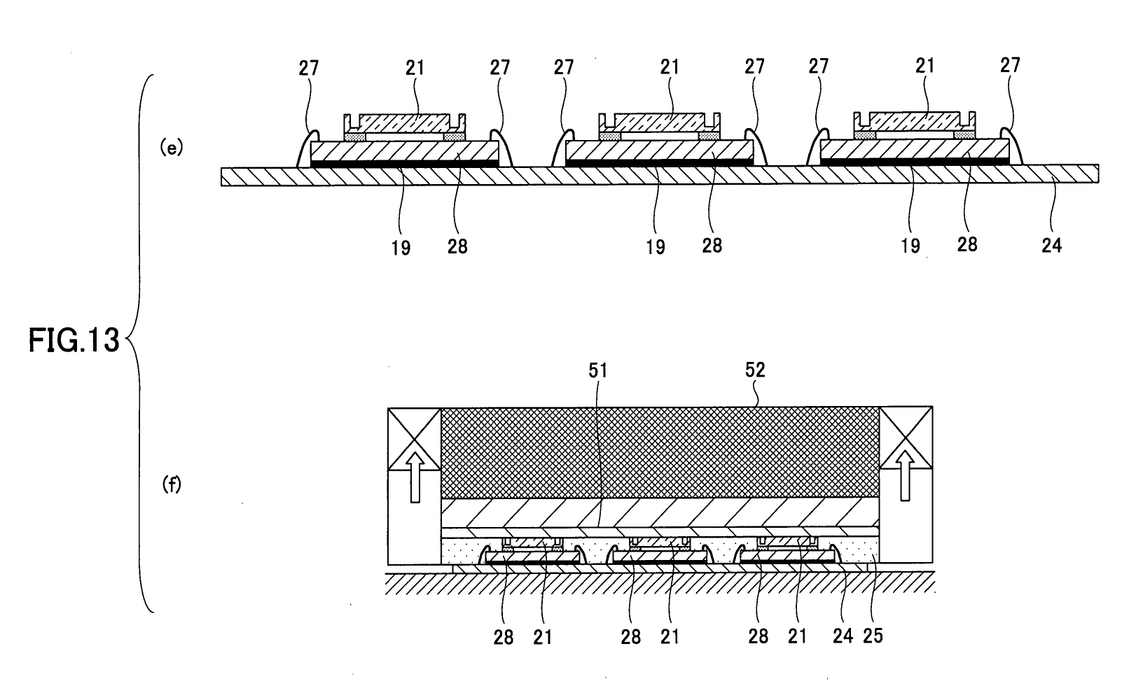

Next, as shown in FIG. 13-(e), an electrode of the solid-state image sensor 28 and an electrode on the wiring board are connected by the bonding wire 27.

After that, as shown in FIG. 13-(f), the solid-state image sensor 28, the transparent member 21, the bonding wire 27, and the wiring board 24 are sealed by the sealing resin 25. In this case, since it is necessary for the surface of the transparent member 21 to be exposed, the surface is sealed by a well known transfer molding method wherein the surface is pushed by a release film 51 and a mold 52 is used.

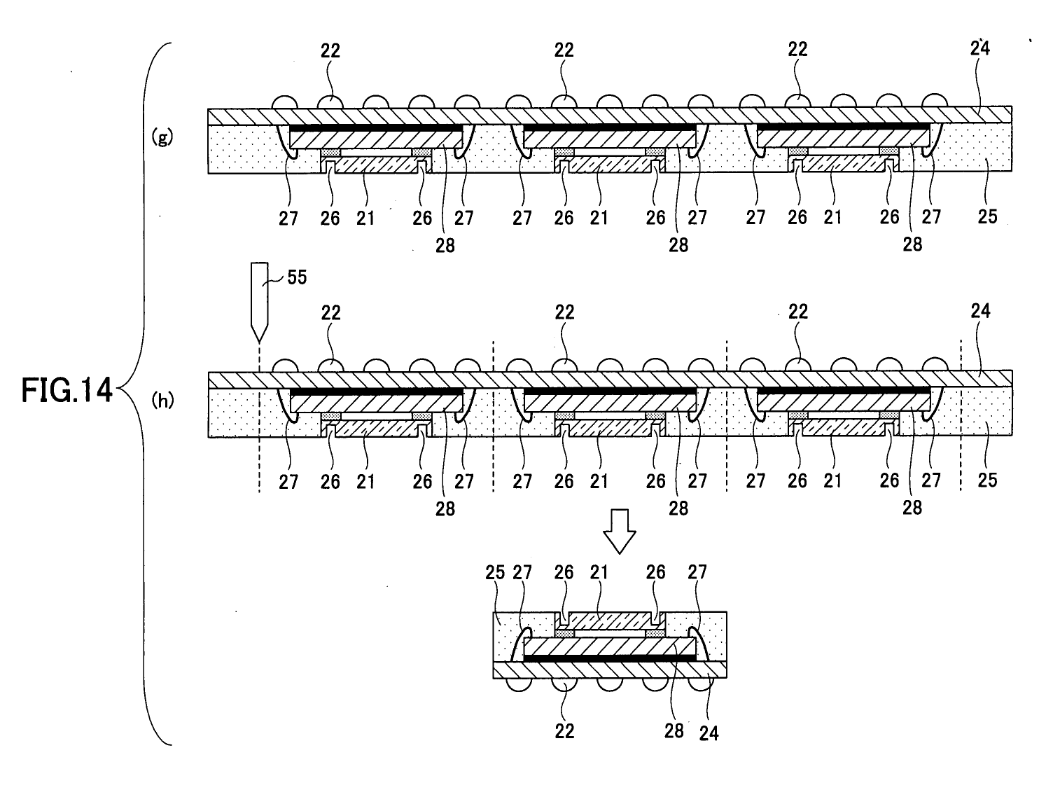

Next, as shown in FIG. 14-(g), outside connection terminal 22 such as soldering balls are formed on the other main surface of the wiring board 24. Then, as shown in FIG. 14-(h), a piece making process is applied by using a dicing blade 55, so that the solid-state image sensing device 20 shown in FIG. 4 is completed.

### 2. Second Example of a Manufacturing Method of the Solid-State Image Sensing Device

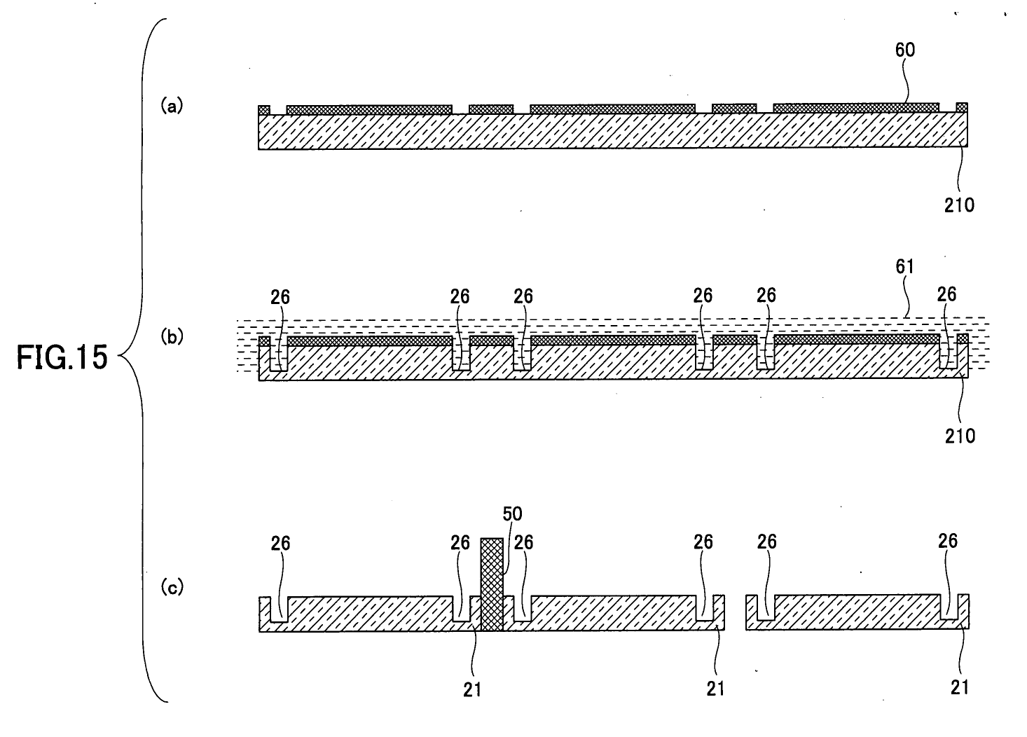

A second example of a manufacturing method of the solid-state image sensing device is discussed with reference to FIG. 15.

Here, FIG. 15 is a view for explaining the second example of the manufacturing method of the solid-state image sensing device of the embodiment of the present invention.

While the groove forming part 26 is formed in the transparent board 210 by using the cutting blade 50 in the first example of the manufacturing method of the solid-state image sensing devices 20, 30 and 40, the groove forming part 26 is formed by etching in the second example.

As shown in FIG. 15-(a), resist 60 is applied to a surface of the transparent board 210. In addition, a part where the groove forming part 26 should be formed by processes shown in FIG. 15-(b) and FIG. 15-(d) is exposed so as to be opened. That is, for a position of the groove forming part 26, the position having the width of approximately 0.05 through 0.2 mm, the corresponding resist 60 position is exposed and opened. Then the groove forming part 26 is formed in the shape of a frame along and in the vicinities of the four sides of the main surface of the transparent member 21 by cutting the transparent member 21 as shown in FIG. 15-(c) so that the side surface 26-1 positioned toward the center of the transparent member 21 is at the same position as or outside of the external edge of the imaging area 29.

Next, as shown in FIG. 15-(b), the transparent board 210 is etched by using etching liquid such as hydrofluoric acid so that the groove forming parts 26 are formed.

As discussed above, while it depend on properties of the solid-state image sensor 28 shown in FIG. 4 and the transparent member 21 shown in FIG. 4, the thickness of the transparent board 210 in up and down directions of FIG. 4 is normally equal to or greater than approximately 0.3 mm and equal to or smaller than approximately 1.5 mm in a case of a mega-pixel type sensor. The etching amount for forming the groove forming part 26 may be approximately 50 through 90% of thickness of the transparent board 210.

After that, as show in FIG. 15-(c), the transparent board 210 is cut so that a part between the neighboring groove forming parts 26 is pierced. As a result of this, plural transparent members 21 where the groove forming parts 26 are formed at both side parts are formed. The size of the transparent member 21 is suitable for the solid-state image sensor 28.

After this, the same processes as the processes of the first example of the manufacturing method of the solid-state image sensing device, namely the process shown in FIG. 12 through FIG. 14, are implemented, so that the solid-state image sensing device 20 is completed.

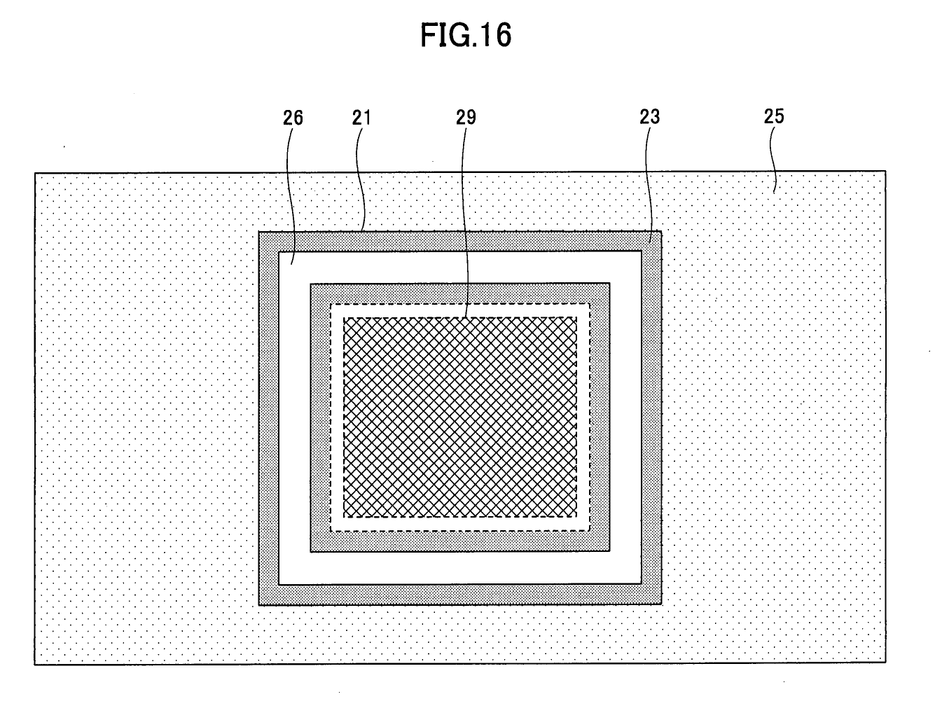

FIG. 16 is a plan view of the solid-state image sensing device 20 manufactured by the second example of the manufacturing method of the solid-state image sensing device of the embodiment of the present invention.

In the second example of the manufacturing method of the solid-state image sensing device, unlike the first example of manufacturing method of the solid-state image sensing device whereby the groove forming part 26 is formed in the transparent board 210 by using the cutting blade 50, the groove forming part 26 is formed by etching. Therefore, the groove forming parts can be easily formed in a frame shape on the main surface of the transparent member 21 without the four groove forming parts 26 crossing each other where the four sides of the main surface form corners.

The present invention is not limited to these embodiments, but variations and modifications may be made without departing from the scope of the present invention.

For example, in the above-discussed embodiments, the groove forming part of the transparent member is formed by using the cutting blade or the etching method. However, a method of forming the groove forming part of the present invention is not limited to these examples. For example, a material of the transparent member such as glass, plastic or the like may be melted in a mold having a configuration corresponding to the groove forming part so that the transparent member having the groove forming part may be formed by molding.

In addition, for example, in the above-discussed embodiments, the solid-state image sensing device is explained as an example of the semiconductor device of the present invention, and the solid-state image sensor is explained as an example of the semiconductor element forming the semiconductor device of the present invention. However, the present invention is not limited to this. The semiconductor element is not limited to the solid-state image sensor such as an image sensor but may be, for example, a fingerprint sensor using glass. In addition, the present invention can be applied to a semiconductor device such as an optical module or Erasable Programmable Read Only Memory (EPROM).

This patent application is based on Japanese Priority Patent Application No. 2006-79062 filed on Mar. 22, 2006, the entire contents of which are hereby incorporated by reference.

What is claimed is:

1. A semiconductor device, comprising:
a semiconductor element having an upper surface where an imaging area is formed;
a transparent member separated from the semiconductor element by a designated distance and facing the semiconductor element; and
a sealing member configured to seal an edge part of the semiconductor element and an edge surface of the transparent member;
wherein a groove forming part is formed in the transparent member, the groove forming part being situated at an edge surface side of the transparent member outside of an external edge of the imaging area of the semiconductor element.

2. The semiconductor device as claimed in claim 1,
wherein a cross section of the groove forming part has a configuration wherein a bottom surface is a plane surface and side surfaces are formed from the bottom surface in a direction substantially perpendicular to the bottom surface.

3. The semiconductor device as claimed in claim 2,
wherein a side surface of the groove forming part, which side surface is positioned toward a center of the transparent member, is at the same position as or outside of the external edge of the imaging area of the semiconductor element.

4. The semiconductor device as claimed in claim 2,
wherein a width of the groove forming part is equal to or greater than approximately 0.05 mm and equal to or smaller than approximately 0.2 mm.

5. The semiconductor device as claimed in claim 1,
wherein a cross section of the groove forming part has a substantially V-shaped configuration.

6. The semiconductor device as claimed in claim 5,
wherein a part of a side surface of the groove forming part whose cross section has the substantially V-shaped configuration, the part being where the side surface of the groove forming part is positioned toward a center of the transparent member, and a main surface of the transparent member come in contact with each other, and
the part is at the same position as or an outside of the external edge of the imaging area of the semiconductor element.

7. The semiconductor device as claimed in claim 1,
wherein a U-shaped cross section of the groove forming part has a configuration wherein a bottom surface is a curved surface and side surfaces are formed from the bottom surface in a direction substantially perpendicular to the bottom surface.

8. The semiconductor device as claimed in claim 7,
wherein a part of a side surface of the groove forming part whose cross section has the substantially U-shaped configuration, the part being where the side surface of the groove forming part is positioned toward a center of the transparent member, and a main surface of the transparent member come in contact with each other, and
the part is at the same position as or outside of the external edge of the imaging area of the semiconductor element.

9. The semiconductor device as claimed in claim 1,
wherein a depth of the groove forming part is approximately 50 through 90% of thickness of the transparent member.

10. The semiconductor device as claimed in claim 1,
wherein a single one of the groove forming part is formed in the vicinity of each of the four sides of a main surface of the transparent member and along the corresponding side.

11. The semiconductor device as claimed in claim 1,
wherein a plurality of the groove forming parts is formed in the vicinity of each of the four sides of a main surface of the transparent member and along the corresponding side.

12. The semiconductor device as claimed in claim 1,
wherein the groove forming part is formed by cutting with a cutting blade; and
a cross section of the groove forming part has a configuration corresponds to a cross-sectional configuration of the cutting blade.

13. The semiconductor device as claimed in claim 1,
wherein the groove forming part is formed by etching the transparent member.
